(19) United States
(12) Patent Application Publication
(10) Pub. No.: US 2014/0331818 A1
(43) Pub. Date: Nov. 13, 2014

(54) FLEXIBLE TUBULAR SHAFT

(71) Applicant: AESCULAP AG, Tuttlingen (DE)

(72) Inventor: Bernhard KUPFERSCHMID, Emmingen-Liptingen (DE)

(73) Assignee: AESCULAP AG, Tuttlingen (DE)

(21) Appl. No.: 14/275,863

(22) Filed: May 12, 2014

(30) Foreign Application Priority Data
May 12, 2013 (DE) 102013208728.4

(51) Int. Cl. F16C 1/20

(52) U.S. Cl. CPC F16C 1/20
USPC 74/579 R; 29/559

(57) ABSTRACT

The disclosed subject matter describes a tubular shaft for a tubular shaft instrument having a hollow shaft component, an actuating rod arranged in the hollow shaft component and functional elements that are disposed at the distal ends of the shaft component and/or the actuating rod. The actuating rod is axially displaceable relative to the hollow shaft component to thereby move the distal segments of the functional elements toward one another, past one another and/or away from one another. The actuating rod has at least one area in which flexible segments and support segments alternate with one another and in which the actuating rod has a clearly lower bending resistance at least in one transverse direction than outside this at least one area. The hollow shaft component additionally has at least one area in which the wall of the shaft component features recesses and the shaft component has, at least in a transverse direction, a clearly lower bending resistance than that outside this at least one area. The at least one areas of the actuating rod and of the shaft component overlap at least partially in the longitudinal direction of the tubular shaft. A friction-reducing layer is provided at the at least one area of the actuating rod, which decreases the friction of the actuating rod at the inner wall of the shaft component. The friction-reducing layer is preferably comprised of a heat-shrink tube.

The disclosed subject matter relates to a tubular shaft for a tubular shaft instrument, in particular a tubular shaft that a surgeon can manually bend into an appropriate shape.

Numerous tubular shaft instruments and thus also numerous tubular shafts are known from the related art. For example, European patent application EP 0577 423 A2 discloses a classic tubular shaft instrument in which a push and pull rod can be moved back and forth axially in a straight shaft to allow the jaw part of the tubular shaft instrument to open and close. In this process, the back-and-forth movement of the push and pull rod is transferred to the branches of the jaw part via a joint mechanism. The push and pull rod can be constructed as a rigid rod. This principle does not facilitate the production of bent tubular shafts.

Tubular shaft instruments with a bent tubular shaft are also already known from the related art. For example, German patent application DE 195 20 717 A1 discloses a tubular shaft instrument having a bent tubular shaft. This tubular shaft instrument employs a shaft having a straight proximal area and bent distal area. In the straight proximal area, a rigid rod is used as a push and pull rod, to the distal end of which a flexible push and pull rod is attached. The flexible push and pull rod is comprised of a rod in which a plurality of circumferential grooves is incorporated, which reduces the cross-section of the rod such that the originally essentially rigid rod becomes flexible. Segments are left between the grooves where the push and pull rod retains its original diameter. These segments enable the push and pull rod to be correctly guided and supported in the bent section of the shaft. The push and pull rod tends in the bent shaft segment to assume not the intended shape of an arc, as it is prescribed by the bent area of the shaft, but rather the shape of a polygonal curve. In this context, the number and spacing of support segments determines the shape of the polygonal curve. However, a tubular shaft constructed in this manner can be provided only with a single bend area.

In many cases, tubular shaft instruments are provided with standardized bends that are tailored to a particular application purpose and average patient anatomy. If, however, the tubular shaft instrument is used for new applications or the patient's anatomy deviates significantly from average anatomy (e.g. obese or anorexic patients), the pre-set bending radii and the lengths of the straight shaft segments arranged intermediately are no longer optimal for the patient.

If it is necessary to provide multiple bend areas on a tubular shaft instrument or if the tubular shaft is to be bent by the surgeon or support personnel only immediately before or even during use, then the shaft must be constructed differently.

An aspect of the disclosed subject matter is thus to provide a tubular shaft for a tubular shaft instrument, where the tubular shaft can be adapted to a patient's specific anatomy.

This aspect is achieved by a tubular shaft for a tubular shaft instrument according to claim 1. Advantageous embodiments of the disclosed subject matter are the subject matter of the dependent claims.

An embodiment of the disclosed subject matter describes a tubular shaft for a tubular shaft instrument having a hollow shaft component, an actuating rod arranged in the hollow shaft component and function elements that are disposed at the distal ends of the shaft component and/or the actuating rod. The actuating rod is axially displaceable relative to the hollow shaft component to thereby move the distal segments of the function elements toward one another, past one another and/or away from one another to allow the functional components such as the blades of scissors, clamps, needle holders, etc. to perform their specific function. The actuating rod has at least one area in which flexible segments and support segments alternate and in which the actuating rod has, at least in a transverse direction, a clearly lower bending resistance than that outside this at least one area. The hollow shaft component additionally has at least one area in which the wall of the shaft component features recesses and the shaft component has, at least in a transverse direction, a clearly lower bending resistance than that outside this at least one area. The at least single areas of actuating rod and of the shaft component overlap along the longitudinal axis of the shaft, at least partially, such that, at the tubular shaft, at least one area is formed in which the entire tubular shaft can be bent. The shaft component is bent primarily plastically, so that the tubular shaft remains in bent form after being bent. The actuating rod can be bent plastically and/or elastically. If moved back and forth in the shaft component and the bending radius of the shaft component is not absolutely consistent over the course of travel of the actuating rod with respect to the shaft component, the actuating rod becomes deformed to a stronger and/or weaker bend during this movement of the actuating rod. A bending of the actuating rod with a greater elastic portion thus leads to a longer service life of the tubular shaft, but simultaneously generates greater restoring force that acts on the shaft component. Bending the actuating rod with a greater plastic portion may decrease the service life of the actuating rod, e.g. owing to the risk of stress whitening; it simultaneously minimizes the restoring force acting on the shaft sleeve, allowing the shaft sleeve to be of thinner or more delicate construction. Furthermore, a friction-reducing layer is provided at the at least one area of the actuating rod, which decreases the friction of the actuating rod at the inner wall of the shaft component.

Such construction makes it possible to produce a tubular shaft for a tubular shaft instrument that can be manually bent to the desired shape on-site and thus can be optimally adapted to the patient and the area (both technically and spatially) of application. In the process the functional parts are attached to the distal end of the shaft component and/or the actuating rod in a conventional manner. A flexible tubular shaft of this type can be designed as a disposable or reusable component that can be mounted on a disposable or reusable handle. If the flexible tubular shaft is designed as a reusable component, it must be possible to clean and sterilize said component. In the case of such a tubular shaft of this type, it is possible for the actuating rod to be designed to be flexible over a clearly larger area than the shaft component. However, a flexible construction of the actuating rod leads to increased friction of the actuating rod or the friction-reducing layer on the interior wall of the shaft component, since the actuating rod tends to buckle laterally when subjected to pushing load, thus resulting in additional pressure on the interior wall of the shaft component. It is thus especially advantageous to design the actuating rod to be flexible only where necessary, specifically in the areas in which the shaft component is flexible. The travel of the actuating rod in the shaft component must of course be factored in here. The friction-reducing layer additionally serves two functions. The first function is to minimize the friction between the actuating rod and the shaft component. This objective is achieved by using a material for this layer that has a lower friction coefficient when interacting with the shaft component than the material of the actuating rod. The actuating rod is normally constructed of metal. Alternatively, the actuating rod can be made of a plastic, and the friction-reducing layer is formed directly through the surface of the actuating rod. The second function of the friction-reducing layer is to balance out deformations that arise in the bending area from flexing the originally circular cross-sections. Bending a circular tube deforms the tube cross-section in the bending area into essentially a nearly circular ellipse. Not providing play or a compensating layer for these deformations would render the tubular shaft barely, if at all, usable after being bent. Providing a gap as play between the actuating rod and the shaft component would diminish accuracy when actuating the tubular shaft. For this reason, using a compensating layer is especially advantageous. Conventional heat-shrink tubes have proven to be especially suitable for reducing the friction between the shaft component and actuating rod. These tubes additionally make a very suitable compensating layer, since they are soft enough to be pressed together at the required places between the shaft component and the actuating rod—particularly the support segments thereof —without generating a high degree of friction between the adjacent components. Furthermore, conventional heat-shrink tubes are especially easy to apply to the actuating rod and are relatively economical to manufacture or procure. A friction-reducing layer can additionally be applied as a coating to the actuating rod or the interior wall of the shaft component. Such a coating could also assume the function of a compensating layer.

According to an advantageous embodiment of the disclosed subject matter, the flexible segments of the actuating rod can be constructed by having the maximum expansion of the cross-section of the actuating rod smaller than that of a support segment in at least one direction.

With such a design, the area moment of inertia decreases as does automatically the bending moment in relation to an axis extending crosswise to the direction of the reduced expansion of the cross-section if a homogenous material is used. In principle, however, multiple preferred bending directions could also be realized by having the actuating rod assume a rectangular or triangular shape, for example. In the case of a rectangle or equilateral triangle, the bending resistance or the force required for bending in the directions prescribed by the cross-sectional shape of the actuating rod are each identical to one another. If more than one bending area is provided in the case of a tubular shaft, the bends can be present in each bending area in one and the same plane. Alternatively, the planes in which the bending in the individual bending areas occurs can be skewed in relation to one another. Another possible alternative is to have a bending area simultaneously bent in multiple spatial directions such that the tubular shaft assumes, for example, a spiral form at this segment.

According to another advantageous embodiment of the disclosed subject matter, flexible segments of the actuating rod are realized by providing recesses in the actuating rod. In this way, the actuating rod can be designed first as a cylindrical rod, which is then provided with recesses to reduce the cross-sectional surface of the actuating rod in the area of the recesses and thereby decrease the area moment of inertia and the bending resistance of the actuating rod. The recesses are preferably designed as straight grooves, which can be easily machined or otherwise incorporated into the actuating rod. Straight grooves additionally have the advantage of creating directional guidance for bending, allowing the user to precisely bend the tubular shaft and thereby the actuating rod as well. It is also advantageous if the grooves extend perpendicular to the longitudinal axis of the tubular shaft, making it especially easy to create the grooves.

According to another advantageous embodiment of the disclosed subject matter, the recesses are arranged in the actuating rod essentially on two radially opposite sides of the actuating rod to thereby define a transverse direction in which the bending stiffness over the entire area is lower than in other transverse directions. In this embodiment, a preferred bending plane is defined for the actuating rod. This prevents, in particular when combined with a corresponding construction of the shaft component described below, the tubular shaft from accidentally being bent in an undesired direction or adversely bent into a three-dimensional shape.

According to another advantageous embodiment of the disclosed subject matter, the recesses are arranged in the wall of the shaft component essentially on two radially opposite sides of the shaft component to thereby define a transverse direction in which the bending stiffness over the entire area is lower than in other transverse directions. This design prevents the tubular shaft from being bent in an unintended direction or adversely bent into a three-dimensional shape. While this design is advantageous in combination with the actuating rod design described above, an appropriate design of the shaft component alone is very beneficial in this respect.

According to another advantageous embodiment of the disclosed subject matter, the recesses in the wall of the shaft component are distributed evenly along the radius of the shaft component, making the bending stiffness of the shaft component essentially the same in all transverse directions. This design enables the user to bend the tubular shaft into any desired shape. In this case, however, the user has to forego any guidance in a preferred bending plane. This construction should also comprise a very wide groove circling the outer wall of the shaft component that can be considered the result of the overlapping of multiple individual recesses.

According to yet another advantageous embodiment of the disclosed subject matter, the recesses in the wall of the shaft component are realized at least partly as passage openings. The recesses, which are realized mostly as grooves, can alternatively be closed at their base. This could prevent foreign substances from penetrating into the interior of the shaft component and possibly compromising the operation of the tubular shaft. The base of each such groove can also be constructed so thin that it breaks when the tubular shaft is flexed under certain conditions. The recesses are preferably realized as straight grooves that preferably extend perpendicular to the longitudinal direction of the tubular shaft. This makes it especially easy to create the recesses in the shaft component.

According to another advantageous embodiment of the disclosed subject matter, a plurality of bending areas is realized on the actuating rod and/or the shaft component. Provided between the two neighboring bending areas is, in this case, an area in which the actuating rod and/or the shaft component is essentially rigid. This type of design is advantageous insofar that in the case of a tubular shaft with more than one bending area, the friction of the actuating rod or the friction-reducing layer at or on the actuating rod is reduced at the inner wall of the shaft component. If the actuating rod is designed to be flexible in the straight areas of the tubular shaft as well, it tends to buckle laterally and abut various points along the inner wall of the shaft component, resulting in increased friction. A virtually rigid construction of the straight areas of the actuating rod essentially prevents this effect completely, thus keeping the friction between the actuating rod or the friction-minimizing layer and shaft component to a minimum.

According to yet another advantageous embodiment of the disclosed subject matter, the at least one area with the actuating rod having a lower bending stiffness extends longitudinally along the tubular shaft at least over essentially the entire at least one area in which the bending resistance of the shaft component is decreased. As an external component, the shaft component has a larger expansion of the cross-section than that of the actuating rod. The shaft component therefore has, even in the areas provided with recesses and thus having reduced bending stiffness, greater area moment of inertia around the respective bending axis than the actuating rod in an area in which it has lower bending stiffness. This is also true particularly because the actuating rod and shaft component are usually dimensioned such that the required forces can be transmitted without having an excessively large cross-section, since this would negate the desired compactness of the tubular shaft. In addition, the actuating rod and shaft component are usually made of the same material. The shaft component thus normally has clearly higher bending stiffness in the specified areas than the actuating rod. When the tubular shaft is flexed by the user, it is accordingly the shaft component above all that determines how much force must be used. To preclude a user from accidentally bending the shaft component in an area in which the shaft component but not the actuating rod is designed for bending and thereby rendering the bent tubular shaft no longer functional, the actuating rod is likewise prepared for bending, e.g. has reduced bending stiffness, at least everywhere the shaft component is prepared for bending.

According to yet another advantageous embodiment of the disclosed subject matter, the transverse direction defined by the recesses of the actuating rod essentially matches the transverse direction defined by the recesses in the shaft component. This ensures that user bending the tubular shaft is clearly guided in the process of bending in the thus established bending plane. This also ensures that the forces prevailing in the tubular shaft between the shaft component and the actuating rod are kept to a minimum. If these transverse directions were clearly skewed in relation to one another, this could result in the actuating rod buckling within the shaft component, causing unnecessary friction between these components.

According to another advantageous embodiment of the disclosed subject matter, the actuating rod and the shaft casing are adapted to enable in the at least one area a variable bending radius in the longitudinal direction of the tubular shaft. This can be accomplished by having, for example, recesses of varying size or number that are provided in the shaft component and/or the actuating rod. If realized as grooves, the recesses can also be designed as triangular grooves, the slopes of which are arranged at various degrees of steepness. This enables bending precisely all the way until the slopes of a groove touch. In this way, each area along the longitudinal direction of the tubular shaft can be prescribed a maximum attainable bend.

According to yet another advantageous embodiment of the disclosed subject matter, a visual and/or tactile labeling of at least one bending area is provided that identifies at least one area of the tubular shaft along the longitudinal direction thereof where an area of the actuating rod with low bending resistance and an area of the shaft component with low bending resistance are located. In this way, the user can simply be shown in which areas a bend can be made without compromising the operability of the tubular shaft. At the same time, the user can also be shown a bending plane where a bend is optimally made, or it can be indicated that a three-dimensional bend is possible in a certain area.

According to yet another advantageous embodiment of the disclosed subject matter, the tubular shaft has a casing that covers the shaft component and the labeling of the at least one bending area is provided on the casing. A casing is advantageous for minimizing the friction of a tubular shaft in a trocar, for example. This type of casing additionally protects against the penetration of contaminants into the tubular shaft, particularly if the recesses provided in the shaft component are designed as passage openings or are opened during a bending maneuver. The casing is preferably elastic enough not to become damaged when the tubular shaft is bent.

According to yet another advantageous embodiment of the disclosed subject matter, the labeling identifies the distal and proximal ends of the at least one bending area and preferably also identifies the center of the at least one bending area. Such a design allows the user to bend the tubular shaft by gripping it outside the bending area where the tubular shaft is of more rugged construction so that the tubular shaft is not accidentally damaged when gripped, for example, through a shaft component wall weakened by the recesses being deformed inwardly in an area between two support segments, which would compromise the operability of the tubular shaft. If, in addition, the center of the bending area is labeled, the user knows the optimal spot or area for achieving maximum curvature of the tubular shaft.

According to yet another advantageous embodiment of the disclosed subject matter, the labeling indicates what bending radius and/or what bending direction is possible at what spot, preferably through the use of different colors or differently sized or spaced symbols or lines. A bend made by the user manually at the place of use of the tubular shaft will result less in a bent tubular shaft with a circular arc-shaped tubular shaft segment, but rather the bent segment of the tubular shaft will assume more the course of a clothoid, i.e. an arc with a variable radius of curvature. To preclude the user from excessively bending the tubular shaft in the peripheral areas of a bending area of a tubular shaft of this type, it can be indicated to the user in this manner what bending radius can be achieved without compromising the functional capability of the tubular shaft in an undesirable manner.

According to yet another advantageous embodiment of the disclosed subject matter, the spacing of the recesses in the wall of the shaft component and the spacing of the support segments of the actuating rod as well as the location of the shaft component and actuating rod can be matched to one another, such that no support segment of the actuating rod can enter a recess in the wall of the shaft component. Otherwise, it is possible that at a certain position of the actuating rod in relation to the shaft component when the tubular shaft is bent, a support segment enters a groove provided in the shaft component and this groove becomes compressed during bending, causing the support segment of the actuating rod to become jammed in this groove. A tubular shaft of this type would be unable to function. To achieve this goal, the spacing between the two neighboring grooves in the shaft component can be selected to be significantly larger than the support segment width and travel length of the two components in relation to one another. Alternatively, a support segment can be wider than a groove of the shaft component can expand on the outside of the bend.

A person skilled in the art can gather additional advantages and features of the disclosed subject matter from the attached figures and the detailed description of the embodiments.

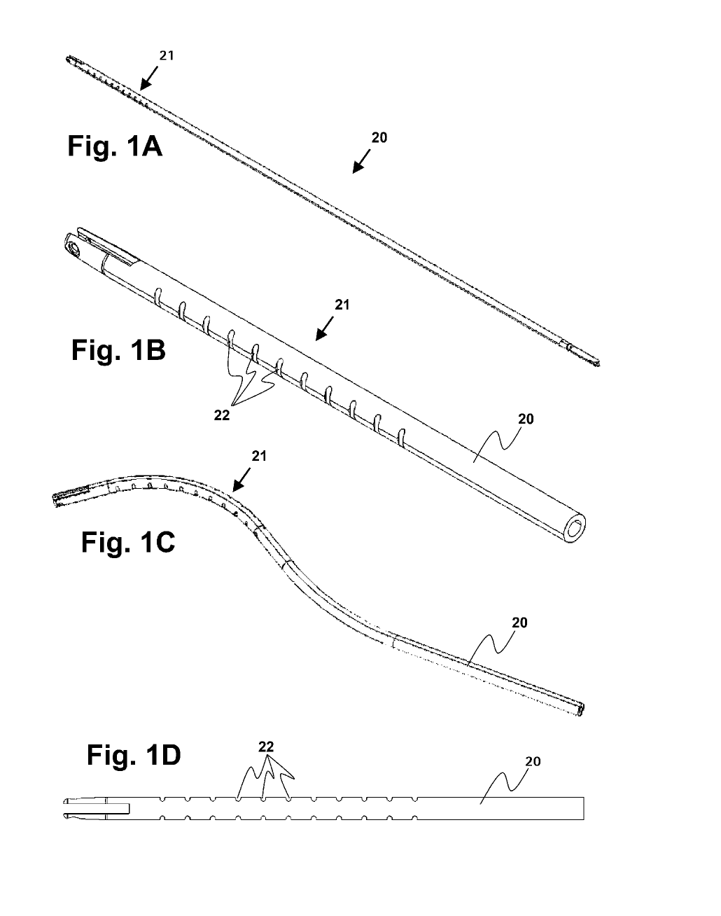

FIG. 1A is an isometric view of a first embodiment of a tubular shaft;

FIG. 1B is an isometric view of the distal end of the tubular shaft of FIG. 1A;

FIG. 1C is a perspective view of the distal end in the bent state of the tubular shaft of FIG. 1A;

FIG. 1D is a top view of the distal end of the shaft component of the tubular shaft of FIG. 1A;

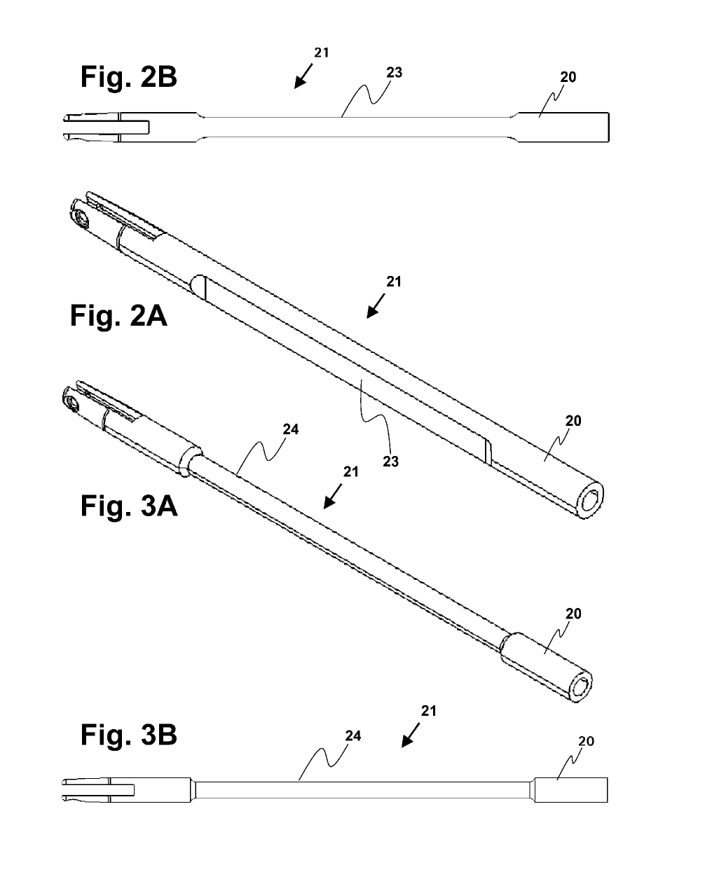

FIG. 2A is an isometric view of a distal end of a second embodiment of a shaft component;

FIG. 2B is a top view of the distal end of the shaft component of FIG. 2A;

FIG. 3A is an isometric view of a distal end of a third embodiment of a shaft component;

FIG. 3B is a top view of the distal end of the shaft component of FIG. 3A;

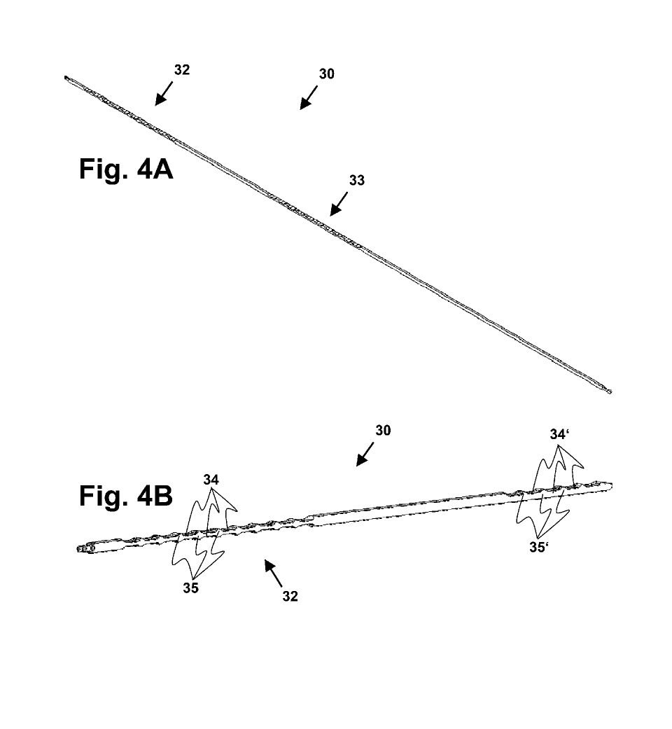

FIG. 4A is an isometric view of a first embodiment of an actuating rod;

FIG. 4B is a perspective view of the distal end of the actuating rod of FIG. 4A;

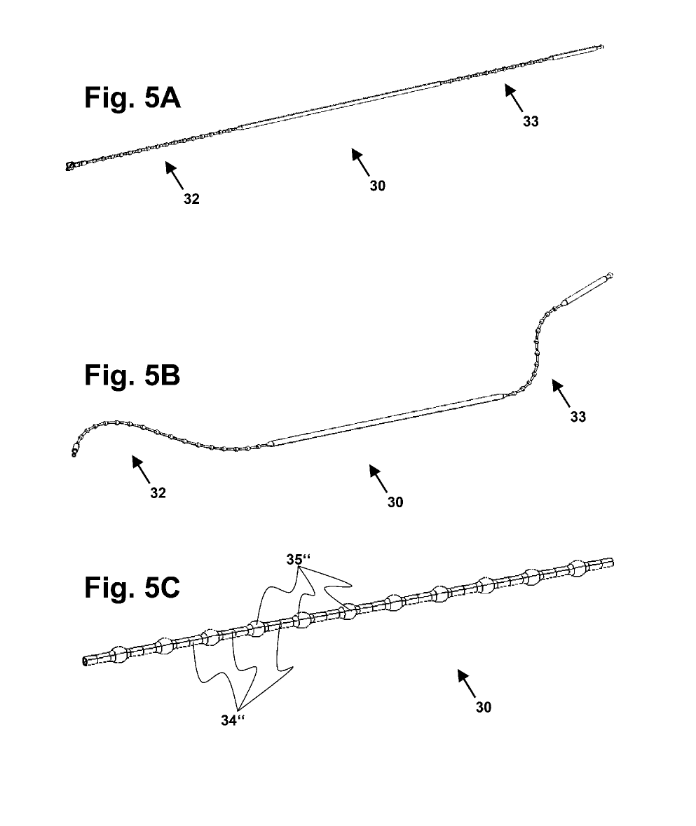

FIG. 5A is a perspective view of a second embodiment of an actuating rod;

FIG. 5B is a perspective view in the bent state of the actuating rod of FIG. 5A; and

FIG. 5C is a detailed view from FIG. 5A.

Embodiments of the disclosed subject matter are described in detail below with reference to the figures. A first embodiment is described in detail with reference to FIGS. 1A-1D and 4A-4B.

FIG. 1A shows a tubular shaft for a tubular shaft instrument with a hollow shaft component 20, an actuating rod 30 arranged in the hollow shaft component 20 and functional elements (not shown) that are attached to the distal ends of the shaft component 20 and the actuating rod 30.

At the proximal end of the tubular shaft a coupling is configured that allows the tubular shaft to be detachably mounted on a handle component. In this embodiment, the tubular shaft is designed as a disposable article to be mounted on a reusable handle part (not shown). For coupling, the shaft casing 20 features ball adaptors into which the balls insert as securing elements to thereby hold the shaft casing 20 on the handle part. The actuating rod 30 features at its proximal end a coupling ball that can be detachably coupled to a corresponding adaptor on the handle part to transfer actuation of the actuating element of the handle part to the actuating rod 30 and to thereby ensure that the function parts work.

The actuating rod 30 is axially displaceable relative to the hollow shaft component 20 to thereby move the distal segments of the function elements toward one another, past one another and away from one another. In this embodiment, the function elements are the blades of a pair of scissors. The actuating rod 30 features two areas 32, 33 in which flexible segments 34, 34′ and support segments 35, 35′ alternate with one another. As FIG. 4B illustrates, the two areas 32, 33 are constructed differently. While in area 32 the flexible support segments 34 are realized by having the actuating rod 30 tapered or provided with grooves starting from opposite sides and having the support segments protruding opposite the flexible segments 34 on two sides opposite the axis, the flexible segments 34′ in area 32 are tapered or provided with grooves on only one side such that the support segments 35′ protrude only on one side opposite the flexible segments 34. In this way, the actuating rod 30 has in two areas 32, 33, at least in one transverse direction, a clearly lower bending resistance than outside these areas 32, 33.

The hollow shaft component 20 likewise features two areas in which the wall of the shaft component 20 features recesses 21, with only the distal area 21 being illustrated in the figures. The shaft component 20 according to this exemplary embodiment features in this area a clearly lower bending resistance in a transverse direction than outside this at least one area 21, with the two areas 21, 32, 33 of the actuating rod 20 and the shaft component 30 overlapping along the longitudinal direction of the tubular shaft.

A friction-reducing layer, which is likewise not illustrated in the figures, is provided at the two areas 21 of the actuating rod 20 to decrease the friction of the actuating rod 20 against the inner wall of the shaft component 30. In this exemplary embodiment, the friction-reducing layer is comprised of a heat-shrink tube.

As mentioned above, the flexible segments 34, 34′ of the actuating rod 30 are constructed by making the maximum expansion of the cross-section of the actuating rod 30 smaller than that of a support segment 35, 35′ in one direction. The flexible segments 34, 35′ are realized through straight grooves extending perpendicular to the longitudinal direction of the tubular shaft. The recesses 22 in the wall of the shaft component 20 are arranged on two radially opposite sides of the shaft component 20 and in this way define a transverse direction in which the bending stiffness is lower over the entire area 21 than in other transverse directions. These recesses 22 are likewise realized as grooves that were machined into the shaft component and are extending perpendicular to the longitudinal direction of the unbent shaft component. These grooves 22 do not open to the interior of the shaft component, even in the bent state as shown in FIG. 1C.

The actuating rod 30 and the shaft component 20 are designed to be essentially rigid between the two areas 32, 33 of the actuating rod 30 and the two areas 21 of the shaft component 20 (of which only one is shown in FIG. 1C). In this context, the term rigid is relative to the reasonably expected forces and moments acting on the tubular shaft, with the bending of the tubular shaft at the intended areas by the user constituting reasonable use of the tubular shaft.

The areas 32, 33 of the actuating rod 30, which are intended for bending, and the areas 21 of the shaft component 20, which are likewise intended for bending, essentially overlap completely, with areas 32, 33 on the actuating rod 30 being slightly larger, since it is necessary to factor in the travel of the actuating rod 30 compared to the shaft component 20. This means that areas 32, 33 are larger than the areas 21 of the shaft component by essentially the length of the travel of the tubular shaft. The actuating rod 30 is arranged in the shaft component 20 such that the transverse direction defined by the recesses of the actuating rod essentially matches the transverse direction defined by the recesses in the shaft component.

FIG. 1C shows the distal end of the shaft component 20 in the bent state. A corresponding bend can also be made if the actuating rod 30 is arranged in the shaft component 20.

A second embodiment of the disclosed subject matter is described in detail with reference to FIGS. 2A-2B and 5A-5C. The following section describes only the differences with respect to the first exemplary embodiment.

In this exemplary embodiment, the shaft component 20 likewise features two areas in which it can be bent by a user. Once again, however, only the distal area 21 of the two areas is shown in FIGS. 2A and 2B. The difference between this exemplary embodiment and the first is that the shaft component 20 is provided with a wide recess 23 on two opposite sides (in relation to the longitudinal axis of the shaft component), which is realized in the form of a groove 23 extending perpendicular to the longitudinal axis.

The actuating rod 20 of this exemplary embodiment differs from the first exemplary embodiment in that the two areas intended for bending are realized in the shape of a string of pearls. This means that the flexible segments 34″, which are shown in FIG. 5C, have a circular cross-section and thus have identical bending resistance in all directions transverse to the longitudinal axis of the actuating rod 30. The support segments 35″ are realized as essentially spherical, with a rounded transition being realized between flexible segments 34″ and support segments 35″. In this exemplary embodiment, the bending plane in which the tubular shaft can preferably be bent is defined exclusively by the shaft component 20. This has the advantage that when assembling the actuating rod 20, the friction-reducing layer and shaft component 30, it is not necessary to consider the rotation of the actuating rod 30 in relation to the shaft component 20, which makes assembly considerably faster and easier. As additionally indicated in FIG. 4A, the linking element for controlling the functional parts is attached to the distal end of the actuating rod 30 by means of a rotating sleeve, so that for this reason as well it is not necessary to rotationally align the actuating rod 30 with the shaft component 20.

A third exemplary embodiment of the present invention is described in detail below with reference to FIGS. 3A-3B and 5A-5C, with only the differences with respect to the second exemplary embodiment being described.

In contrast to the second exemplary embodiment, the shaft component 20 of the third exemplary embodiment features two areas intended for bending that do not prescribe a bending plane. FIG. 3 likewise shows only the distal area 21 of the two areas intended for bending. More specifically, the recesses 24 in the wall of the shaft component 20 are distributed evenly along the radius of the shaft component 20, making the bending stiffness of the shaft component 20 essentially equal in all transverse directions. This means that the tubular shaft of the third exemplary embodiment is suitable for three-dimensional bending, but does not offer the user any directional guidance for this purpose. If, however, three-dimensional bending is not desired in the case of such construction, a preferred or intended bending plane for both areas can be indicated through appropriate labeling on the shaft component 20 or a casing thereof.

To make it easier for the user to bend the tubular shaft and decrease the risk of accidentally kinking the tubular shaft when bending, a template can be used. Such a template can have a fixed radius, and different templates with different radii can be used. Curve templates having multiple variable radii of this type are known from the prior art. As an alternative, a template can be used that has different radii or at least an arc of variable radius. For shaping bent tubular shafts that are used more frequently, templates can also be used that have fixed radii for multiple bending areas of the tubular shaft. In the case of all of the aforementioned bending templates, it is advantageous if the bending edge features a groove that can accommodate a portion of the shaft component 20, so that the shaft component 20 is held in place by this groove and does not slip out of the bending radius. Advantageously, this groove has a semicircular cross-section and/or has virtually the same diameter as the shaft component 20.

A person skilled in the art can combine the described features of the tubular shaft from the different exemplary embodiments in any suitable manner at their discretion.

1. A tubular shaft for a tubular shaft instrument comprising a hollow shaft component, an actuating rod arranged in the hollow shaft component and functional elements, which are disposed on the distal ends of the shaft component and/or the actuating rod, wherein the actuating rod is axially displaceable relative to the hollow shaft component to thereby move the distal segments of the functional elements toward one another, past one another and/or away from one another,
and wherein
the actuating rod has at least one area in which flexible segments and support segments alternate and in which the actuating rod has a clearly lower bending resistance in at least one transverse direction than outside this at least one area,
and the hollow shaft component has at least one area in which the wall of the shaft component has recesses and the shaft component has a clearly lower bending resistance in at least one transverse direction than outside this at least one area, wherein the at least one areas, of the actuating rod and of the shaft component overlap at least partly in the longitudinal direction of the tubular shaft, and
a friction-reducing layer is provided at the at least one area of the actuating rod, which decreases the friction of the actuating rod against the inner wall of the shaft component, wherein the friction-reducing layer is comprised of a heat-shrink tube.

2. The tubular shaft for a tubular shaft instrument according to claim 1, wherein
the flexible segments of the actuating rod are constructed by making the maximum expansion of the cross-section of the actuating rod smaller than that of a support segment in at least one direction.

3. The tubular shaft for a tubular shaft instrument according to claim 1, wherein
the flexible segments of the actuating rod are constructed by providing recesses in the actuating rod, which are realized as straight grooves and which extend perpendicular to the longitudinal direction of the tubular shaft.

4. The tubular shaft for a tubular shaft instrument according to claim 3, wherein
the recesses in the actuating rod are arranged essentially on two radially opposite sides of the actuating rod to thereby define a transverse direction in which the bending stiffness is lower over the entire area than in other transverse directions.

5. The tubular shaft for a tubular shaft instrument according to claim 1, wherein
the recesses in the wall of the shaft component are essentially arranged on two radially opposite sides of the shaft component to thereby define a transverse direction, in which the bending stiffness is lower over the entire area than in other transverse directions.

6. The tubular shaft for a tubular shaft instrument according to claim 1, wherein
the recesses in the wall of the shaft component are distributed evenly along the radius of the shaft component, making the bending stiffness of the shaft component essentially equal in all transverse directions.

7. The tubular shaft for a tubular shaft instrument according to claim 1, wherein
the recesses in the wall of the shaft component are realized, at least partially, as passage openings and/or as straight grooves, extending perpendicular to the longitudinal direction of the tubular shaft.

8. The tubular shaft for a tubular shaft instrument according to claim 1, wherein
a plurality of bending areas is realized on the actuating rod 30 and/or on the shaft component and wherein an area is provided between two neighboring bending areas, at which the actuating rod and/or the shaft component is essentially rigid.

9. The tubular shaft for a tubular shaft instrument according to claim 1, wherein
the at least one area in which the actuating rod has a lower bending stiffness extends longitudinally along the tubular shaft at least over essentially the entire at least one area in which the bending resistance of the shaft component is decreased.

10. The tubular shaft for a tubular shaft instrument according to claim 1, wherein
the transverse direction defined by the recesses of the actuating rod essentially matches the transverse direction defined by the recesses in the shaft component.

11. The tubular shaft for a tubular shaft instrument according to claim 1, wherein
the actuating rod and the shaft component are adapted to allow in the at least one area a variable bending radius in the longitudinal direction of the tubular shaft.

12. The tubular shaft for a tubular shaft instrument according to claim 1, wherein
a visual and/or tactile labeling of at least one bending area is provided, which identifies at least one area of the tubular shaft along the longitudinal direction thereof, at which an area of the actuating rod with low bending resistance and an area of the shaft component with low bending resistance are located.

13. The tubular shaft for a tubular shaft instrument according to claim 12, wherein
the tubular shaft has a casing that covers the shaft component and the labeling of the at least one bending area is provided on the casing.

14. The tubular shaft for a tubular shaft instrument according to claim 12, wherein
the labeling identifies the distal and proximal ends of the at least one bending area and also identifies the center of the at least one bending area.

15. The tubular shaft for a tubular shaft instrument according to claim 12, wherein
the labeling indicates what bending radius and/or what bending direction is possible at what spot, through the use of different colors or differently sized or spaced symbols or lines.

16. The tubular shaft for a tubular shaft instrument according to claim 1, wherein
the spacing of the recesses in the wall of the shaft component and the spacing of the support segments of the actuating rod as well as the location of the shaft component and the actuating rod in the axial direction can be matched to one another, such that no support segment of the actuating rod can enter a recess in the wall of the shaft component.

17. A method of making a tubular shaft for a tubular shaft instrument, comprising:
using a bending template for bending the tubular shaft for the tubular shaft instrument.
